(19) United States
(12) Patent Application Publication
(10) Pub. No.: US 2002/0132547 A1
(43) Pub. Date: Sep. 19, 2002

(54) Breathable nonwoven/film laminate

(76) Inventors: Pierre D. Grondin, Mooresville, NC (US); Paul Anthony Kamnikar, Mooresville, NC (US); Valeria Griep Erdos, Mooresville, NC (US); Richard James Witmeyer, Mooresville, NC (US); Marlene Storzer, Mooresville, NC (US); Charles Pearce, Mooresville, NC (US)

Correspondence Address: ROCKEY, MILNAMOW & KATZ, LTD., Two Prudential Plaza, Suite 4700, 180 North Stetson Avenue, Chicago, IL, 60601, US

(21) Appl. No.: 09/759,845

(22) Filed: Jan. 12, 2001

(51) Int. Cl. B32B 3/00; B32B 5/02; B32B 9/00; B32B 5/18; B32B 5/22; D04H 3/16

(52) U.S. Cl. 442/401; 442/59; 442/76

(57) ABSTRACT

A nonwoven fabric/film laminate material is particularly suited for use as a “housewrap”, or in like building construction applications. The laminate material comprises a spunbond polypropylene nonwoven fabric, and a breathable, polymeric film which is extrusion-coated onto the nonwoven fabric layer. Both the fabric layer and extrusion-coating can be formed in a cost-effective manner on conventionally available processing equipment. By appropriate selection of the nonwoven fabric layer and film properties, the present laminate material acts as an effective barrier to liquid water and air infiltration, while providing desirable permeability to water vapor.

### TECHNICAL FIELD

The present invention relates generally to nonwoven fabric and polymer film laminate structures, and more particularly to a breathable nonwoven/film laminate exhibiting liquid barrier properties and vapor permeability, thereby facilitating use of the laminate as a barrier element in building construction.

### BACKGROUND Of THE INVENTION

In recent years, it has become increasingly common to affix a thin barrier layer about a house or like building under construction with a material commonly referred to as a “housewrap”. This type of material first serves to protect the house structure from the elements during construction. For this reason, the material must be reasonably waterproof in order to limit ingress by rain, and especially infiltration caused by wind-driven rain. Such housewrap material serves the additional purpose of preventing excessive air infiltration, thereby increasing the effectiveness of the building's insulation material.

In order to perform as a housewrap material, a nonwoven fabric or laminate structure needs to meet stringent requirements as specified by applicable building codes. Some of the essential requirements are particularly related to the following properties:

a) impermeability to liquid water as measured by the absence of leaks when the housewrap material is subjected to a given hydrostatic head;

b) a minimum moisture vapor transmission rate (MVTR) to ensure that in the event that water vapor (or even liquid water) infiltrates within the wall cavity, it can escape easily and not cause extended damage;

c) resistance to air infiltration (as typically measured by ASTM E-283, or the Gurley test method); and

d) sufficient strength to withstand wind forces after installation, and the moderate level of physical abuse that can be experienced on a construction site.

The housewrap material should exhibit satisfactory ultraviolet (UV) stability so as to maintain most of its strength after 60 days of exposure to the elements. Strength is often specified in accordance with the strip tensile method, ASTM D882, as well as the trapezoidal test method, ASTM D5733-05.

A number of housewrap products have been introduced over the years which have provided varying degrees of success in meeting the needs of this type of application. One type of product is a spunflash fabric commercially available from the DuPont Corporation under the trade name “TYVEK” and disclosed in U.S. Pat. No. 5,863,639, U.S. Pat. No. 6,046,118 and U.S. Pat. No. 6,070,635. The relatively tight structure of this fabric provides very good resistance to liquid water penetration, while still exhibiting a relatively high moisture vapor transmission rate. While this type of product exhibits good tensile strength, it has relatively low trapezoidal tear strength. Relatively high tear strength is believed to contribute to a product's durability, such as exhibited by staple retention. Because this product is made of very closely spaced fibers, the interstical regions between the fibers render the product porous. As a consequence, there is an ongoing concern that soaps, surfactants, or extracts from wood or other construction materials will adversely affect the surface tension of the fabric, thus reducing the water resistant quality of the product.

Another family of housewrap products consists of either woven or nonwoven fabrics that are extrusion-coated with a polymer film, and subsequently punctured with fme needles, as typified by U.S. Pat. No. 5,888,614. The micro-perforations thus formed in the type of material are of such small diameter that water transmission is impaired and a hydrostatic head can build against the fabric. Additionally, such products exhibit relatively good strength. However, because the perforations can act to limit the water impermeability performance of the product, when the hydrostatic head of water exceeds the opposing force created by the surface tension the fabric begins to leak. Because the perforations in such products are essentially large capillaries, a concern exists that the barrier product properties of the material will be negatively affected by the presence of soaps, surfactant, or extracts from woods or other building materials in contact with the material. Further, the mechanical nature of the micro-perforation process is such that issues of needle robustness and the quality of the perforations deleteriously affect manufacturing efficiency.

A third generic family of housewrap products consists of a micro-porous film laminated to a strong, open support structure. An example of this type of material is the “CLAF cross-laminated scrim, as registered to Nippon Petrochemicals and commercially available from ANCI. These types of materials are relatively expensive because of the numerous steps required for manufacture, and the micro-porous film is easily abraded. Because the micro-porous film used in this type of laminate material provides moisture transmission by the presence of pores, there is again a concern with this type of material that soaps or surfactants may negatively impact its performance.

In view of the foregoing, it is particularly desirable to provide a material for housewrap and like building applications which exhibits the desired barrier/breathability properties, and sufficient durability to withstand use in building construction, while being sufficiently inexpensive as to permit its affordable use.

### SUMMARY OF THE INVENTION

The present invention is directed to a nonwoven fabric/film laminate material which is particularly suited for cost-effective use as a barrier housewrap or like building envelope. The material is formed from a high strength polypropylene spunbond fabric that can be efficiently made on typical spunbonding equipment. The material further includes an extrusion-coated, monolithic and breathable polymer film. This laminate structure provides exceptional hydrostatic head performance, excellent resistance to soaps or surfactants, and a targeted moisture vapor permeability, while meeting all of the typical building code requirements.

A laminate material embodying the principles of the present invention comprises a spunbond, polypropylene nonwoven fabric layer, and a monolithic, polymeric breathable coating applied to the nonwoven fabric layer. The breathable coating exhibits substantial impermeability to liquid water and air, while exhibiting significant permeability to water vapor. These characteristics of the present laminate fabric facilitate its use in building construction, particularly as a barrier “housewrap” for enveloping a building being constructed.

The nonwoven fabric layer of the present laminate material has a basis weight between about 60 and 100 grams/meter², preferably between 75 and 90 grams/meter2, and is formed from polypropylene having a viscosity, as measured in melt flow rate (MFR) of between about 6 and 16 MFR, with the range of 8 to 13 MFR being preferable. The polypropylene may include additives selected from the group consisting of ultraviolet stabilizers and thermal stabilizers, with the fabric exhibiting a strip tensile strength of at least about 50 N/cm, machine-direction, and at least about 35 N/cm, cross-direction, when tested in accordance with ASTM method D882, with an initial jaw separation of 10 cm, and a cross head speed of 5 cm/minute.

The polymeric breathable coating of the present laminate material is extrusion-coated on the nonwoven fabric layer, and has a thickness of about 15 to 30 g/meter. The polymeric coating comprises, by weight, from about 35 to 90% of a copolymer selected from the group consisting of ethylmethylacrylate (EMA), ethylbutylacrylate (EBA), and ethylvinylacrylate (EVA), and from about 10 to 65% of a copolyester or thermoplastic elastomer selected from the group of copolyether-ester and copolyester-ester block copolymers. The breathable coating may further comprise one or more additives selected from the group consisting of ultraviolet and thermal stabilizers, polyolefin resin grafted with maleic anhydride, and resin modifier based on ethylene acrylate copolymer. More preferably, the acrylate copolymer is an ethyl methyl acrylate or an ethyl butyl acrylate copolymer having a viscosity of between 3 and 12 MFR, as measured at 190° C. and at 2.16 kg. Preferably, the breathable coating may comprise about 10 to 65% of a copolyester block copolymer where the butylene terephthalate hard segments and polyalkylene oxide soft segments alternate. The polymeric coating may also include stability-enhancing and adhesion-enhancing resin modifiers.

Other features and advantages of the present invention will become readily apparent from the following detailed description.

### DETAILED DESCRIPTION

While the present invention is susceptible of embodiment in various forms, there is disclosed herein presently preferred embodiments, with the understanding that the present disclosure is to be considered as an exemplification of the invention, and is not intended to limit the invention to the specific embodiments disclosed herein.

The present invention is directed to a laminate material comprising a nonwoven fabric layer and polymeric film coating which can function as a cost-effective, so-called “housewrap”, that is, a barrier material which can be applied to a building during construction to provide a barrier against liquid and air infiltration, while providing “breathability” to facilitate moisture vapor transmission. As disclosed herein, the laminate material comprises a high-strength polypropylene spunbond nonwoven fabric that can be efficiently made on typical spunbonding equipment. The laminate material further comprises an extrusion-coated monolithic and breathable polymeric film. The present laminate material provides exceptional hydrostatic head performance, and a targeted moisture vapor permeability, with the laminate material meeting all typical building code requirements.

Experience has shown that typical polypropylene spunbond, made on conventional manufacturing equipment, does not exhibit the strength required for construction-related applications when the spunbond has a basis weight less than about 102 grams/meter2. Above that basis weight, the cost of the spunbond material becomes prohibitive, and the weight of the fabric becomes excessive for proper handling by users. By forming a laminate material by extrusion-coating of the polypropylene spunbond with a polymeric film selected for specific barrier characteristics, a cost-effective product is provided, providing a highly desirable combination of strength and barrier properties.

The polypropylene spunbond employed for the nonwoven fabric layer of the present laminate material is selected to have a viscosity between about 6 and 16 MFR. This type of material can be economically formed on a conventional spunbond manufacturing line. Significantly, this type of nonwoven fabric has shown a 40 to 60% increase in strength over a similar spunbond fabric made on the same equipment using a typical 35 MFR polypropylene resin. By way of example, an 85 grams/meter² fabric formed in accordance with the present invention on a Reicofil process was tested for strip tensile strength in accordance with ASTM D882, performed at 5 cm per minute cross head speed, and using a 10 cm initial jaw separation. The fabric exhibited a machine-direction strip tensile strength above 50 N/cm, and a cross-direction tensile strength above 35 N/cm. For application of this material as a housewrap in accordance with the present invention, the polymer was stabilized with a suitable ultraviolet stabilizer package.

Spunbond nonwoven fabric formed as described above was subsequently extrusion coated with a blend comprising, by weight, from about 35 to 90% of a copolymer selected from the group consisting of polyethylmethylacrylate, polyethylbutylacrylate, and polyethylvinylacrylate, and from about 10 to 65% of a copolyester or thermoplastic elastomer selected from the group consisting of copolyether-ester or copolyester-ester block copolymers. A facultative ultraviolet stabilizer was provided. In a preferred embodiment, the copolymer is a polyethylmethylacrylate having an MFR between about 3 and 12 (grams/minute at 190° C. and 2.16 KG) and a methylacrylate content between about 15 and 28%. The copolyester is preferably a copolyether-ester block copolymer having a suitable viscosity that allows good mixing with the acrylate copolymer. The ultraviolet stabilizer package is selected as is known in the art. The coating polymeric blend can also include additives selected from the group consisting of polypropylene or polyethylene grafted with maleic anhydride (an example being “FUSABOND” 225, produced by DuPont Canada) and a resin modifier copolymer (such as “ELVALOY” PTW, sold by DuPont de Nemours, USA). These additives are used to improve the compatibility between the acrylate copolymer and the copolyester, increasing the maximum temperature at which they can be extruded. The ratio between the ingredients and the thickness of this coating are selected to produce the desired moisture vapor permeability.. For example, a useful blend ratio of copolyester to acrylate based copolymer is in a range of about 1:0.75 to 1:9, with the range of 1:1.5 to 1:4 being most preferred. The film coating is typically in a weight range of about 15 to 30 grams/meter², and preferably in the range of 22 to 28 grams/meter² is contemplated.

### EXAMPLES

Example 1: An 88 gsm nonwoven made on a Reicofil line from a blend of 96.7% 8 MFR Polypropylene commercially available from Aristech Chemical Co., 3% UV concentrate and 0.3% blue pigment produced on a Reicofil 3 type process. Process conditions were selected to produce Strip Tensile strength as per ASTM D882 of 54 N/cm for MD and 42.5 N/cm for CD direction. This fabric was subsequently extrusion coated on a typical commercial equipment made by Black-Clawson. A coating of approximately 27 to 28 gsm was applied using a blend of 76% EMA containing 20% methyl acrylate (MA), 20% of a copolyester from DSM Engineering plastic known as PL380, and finally 4% of a UV stabilizer concentrate produced by TechmerPM using a similar EMA as matrix. The melt temperature was 250° C. MVTR was subsequently measured on such fabric using the ASTM E96 method A (Desiccant method) in an environment at 22° C. and 50% relative humidity. The desiccation cells used had a 3.87×10⁻³ meter² opening and the desiccant was calcium chloride anhydride in a granular form of 4 to 20 mesh size. Results are reported in Table 1.

Example 2: A sample was made by extrusion coating a high strength spunbond polypropylene fabric with a 35/58/4/2/1 blend of block copolymer PL380, EMA with a 20% MA content, a UV concentrate, “FUSABOND” 225 (a polyethylene grafted with maleic anhydride) and “ELVALOY” PTW. The coating temperature was 270° C. Results are also reported in Table 1.

TABLE 1

| | Typical SBPP | Typical high | Example 1 | Example 2 |
|---|---|---|---|---|
| | produced on | strength SBPP | Coated sample | Coated sample |
| | the same | made of 8 MFR | (27-28 gsm | (−26 gsm |
| Properties | equipment | PP prior to coating | coating) | coating) |
| Basis weight gsm | 85 | 90 | 118 | 112 |
| Strip tensile as per | pending | 54/42.5 | 55/43.5 | pending. |
| ASTM D882-N/cm | | | | |
| Machine-direction/ | | | | |
| Cross-direction | | | | |
| Grab tensile strength | 86/86 | 137/121 | pending | pending |
| as per ASTM D 5034- | | | | |
| 95 - N/cm Machine- | | | | |
| direction/Cross- | | | | |
| direction | | | | |
| Permeance as per | pending | pending | 7.5 | 9.1 |
| ASTM E 96-95 | | | | |
| method A (desiccant) | | | | |
| performed at 22° C. | | | | |
| and 50% R.H. Perms | | | | |

The laminate barrier material formed in accordance with the present invention is believed to provide several distinct advantages over prior art materials. It is believed that the present invention desirably provides a nonwoven fabric material made from a polypropylene resin having an MFR less than 16, which has been combined with a monolithic polymeric coating to meet all of the requirements for use as a housewrap, or in like construction applications. Heretofore, housewrap-type products formed from nonwoven fabrics have required fabrics made on specialized equipment, frequently unique to a specific supplier. Significantly, the nonwoven fabric employed in the 30 practice of the present invention can be made in a highly cost-effective manner on commercially available equipment. Moreover, the present laminate contemplates use of a cost-effective monolithic film which resists the effects of soaps and surfactants. Again, conventional extrusion-coating equipment can be employed for application of this polymeric coating.

Testing of the material formed in accordance with the present invention has further shown that a hydrostatic head in excess of 125 cm, per test method AATCC-127, and as resistance in excess of 300 seconds per 100 cc are routinely obtained.

From the foregoing, it will be observed that numerous modifications and variations can be effected without departing from the true spirit and scope of the novel concept of the present invention. It is to be understood that no limitation with respect to the specific embodiments disclosed herein is intended or should be inferred. The disclosure is intended to cover, by the appended claims, all such modifications as fall within the scope of the claims.

What is claimed is:

1. A laminate material comprising a spunbond polypropylene nonwoven fabric layer, and a monolithic, acrylate/polyester breathable coating applied to said polypropylene nonwoven fabric layer, said breathable coating exhibiting substantial impermeability to liquid, water, and to air, while exhibiting significant permeability to water vapor.

2. A laminate material in accordance with claim 1, wherein:
said nonwoven fabric layer has a basis weight between about 60 to 100 grams/meter², and is formed from polypropylene having a viscosity between about 6 and 16 MFR.

3. A laminate material in accordance with claim 2, wherein:
the viscosity of the polypropylene is in the range of 8 to 13 MFR.

4. A laminate material in accordance with claim 2, wherein: said polypropylene includes additives selected from the group consisting of ultraviolet stabilizers, thermal stabilizers, and the combinations thereof.

5. A laminate material in accordance with claim 2, wherein: said nonwoven fabric layer has a strip tensile strength of at least about 50 N/cm, machine-direction, and at least about 35 N/cm, cross-direction.

6. A laminate material in accordance with claim 1, wherein: said polymeric breathable coating is extrusion-coated on said nonwoven fabric layer, and has a thickness of about 15 to 10 grams/meter, said coating comprising by weight from about 35 to 90 percent of a copolymer selected from the group consisting of ethylmethylacrylate, ethylbutylacrylate, and ethylvinylacrylate, and from about 10 to 65 percent of a copolyester or thermoplastic elastomer selected from the group of copolyether-ester and copolyester-ester block copolymers.

7. A laminate material in accordance with claim 6, wherein:
said breathable coating further comprises one or more additives selected from the group consisting of ultraviolet and thermal stabilizers, polyolefin resin grafted with maleic anhydride, and resin modifier based on the ethylene acrylate copolymer.

8. A laminate material in accordance with claim 1, wherein:
said polymeric breathable coating has a basis weight of 15 to 30 grams per square meters and comprises a blend containing by weight percent about 35 to 90% of copolymer selected from the group consisting of ethylmethylacrylate or ethylbutylacrylate where the methylacrylate or butylacrylate content is between 15 and 28%, and about 10 to 65% of a copolyester block copolymer where the butylene terephthalate hard segments and poly(alkylene oxide) soft segment alternate.

9. A laminate material in accordance with claim 8, wherein:
said polymeric coating further comprises one or more additives selected from the group consisting of ultraviolet and thermal stabilizers, maleic anhydride grafted polyolefin, and stability-enhancing and adhesion-enhancing resin modifiers.

10. A laminate material in accordance with claim 1, wherein:
said nonwoven fabric layer comprises polypropylene having a viscosity between 3 and 12 MFR, having a basis weight between 60 and 100 grams per square meter, and strip tensile strength of at least about 50 N/cm, machine-direction, and 35 N/cm, cross direction, said polymeric coating being extrusion-coated on said nonwoven fabric layer and having a basis weight of about 15 to 30 grams per square meter, and comprising by weight a blend containing about 35 to 90% of copolymer selected from the group consisting of ethylmethylacrylate and ethylbutylacrylate where the methylacrylate or butylacrylate content is between 15 and 28%, and 10 to 65% of a copolyester block copolymer where the butylene terephthalate hard segments and polyalkylene oxide soft segment alternate.

11. A laminate material in accordance with claim 10, wherein:
said breathable coating further comprises one or more additives selected from the group consisting of ultraviolet and thermal stabilizers, polyolefin resin grafted with maleic anhydride, and resin modifier based on the ethylene acrylate copolymer.

12. A laminate material in accordance with claim 10, wherein the polymeric coating is in the range of 22 to 28 grams/meter²

13. A laminate material in accordance with claim 10, wherein:
the material is used as a housewrap.
